(19) United States
(12) Patent Application Publication
(10) Pub. No.: US 2011/0253850 A1
(43) Pub. Date: Oct. 20, 2011

(54) FOLDABLE STAND FOR PORTABLE HANDHELD ELECTRONIC DEVICE

(75) Inventor: Chi Vun Steven BAU, Hong Kong (HK)

(73) Assignee: SwitchEasy Limited, Hong Kong (HK)

(21) Appl. No.: 13/006,053

(22) Filed: Jan. 13, 2011

(30) Foreign Application Priority Data
Apr. 15, 2010 (HK) 10103690.5

(51) Int. Cl. F16M 11/38

(52) U.S. Cl. 248/176.3

(57) ABSTRACT

A foldable stand for portable handheld electronic device, which may comprise: a base into an upper surface of which a groove is formed; a cover pivotably connected to the base for covering the upper surface of the base; a strut pivotably connected to the cover at an upper edge thereof and slidably mounted in the groove at a lower edge thereof; in which the groove is formed in such a manner that it could contain the strut when the cover is closed with respect to the base.

### CROSS-REFERENCE TO RELATED APPLICATIONS

The application claims the priority benefits of Hong Kong Short-Term Patent Application No. 10103690.5 filed on Apr. 15, 2010, the contents of which are hereby incorporated by reference in its entirety.

### FIELD OF THE INVENTION

The present invention generally relates to a stand for supporting portable handheld electronic devices, and more particularly to a stand being foldable when not being in use.

### BACKGROUND OF THE INVENTION

Due to the convenience for use, portable handheld electronic devices, such as Apple iPhone, personal digital assistant (PDA), digital media players, digital recorders, potable TV, handheld computers, etc., are more and more popular in modern life.

Usually, a user holds such an electronic device with one hand, and operates the same with the other hand. However, after operation on the electronic device is finished, the user would generally put down the electronic device and let the same operate automatically. For example, after operation on a digital media player is finished, the user would put down the player and let it play songs automatically. As such an electronic device is covered with smooth and beautiful surface, the delicate finish of the electronic device would be subject to deterioration or damage if the electronic device is put directly on a desk. Besides, due to the smooth surface of the electronic device, there is a risk that the electronic device would slide off from the desk to incur a serious damage. Therefore, a stand is needed to support the electronic devices stably.

Furthermore, to demonstrate the new functions of such portable handheld electronic devices to potential customers, stands for supporting the electronic devices are also demanded.

Although there are some kinds of stands available in the market, such stands are unfoldable and would occupy a lot of space, which makes it difficult to store and deliver such stands.

Therefore, it is desirable to have a foldable stand for portable handheld electronic devices, which could be used to support electronic devices in an unfolded state, while be easy for storage or delivery after being folded.

### SUMMARY OF THE INVENTION

To overcome the above-mentioned faults, the present invention aims to provide a foldable stand for portable handheld electronic device which may comprise: a base into an upper surface of which a groove is formed; a cover pivotably connected to the base for covering the upper surface of the base; a strut pivotably connected to the cover at an upper edge thereof and slidably mounted in the groove at a lower edge thereof; in which the groove is formed in such a manner that it could contain the strut when the cover is closed with respect to the base.

Preferably, a projection could be formed outwards from each side of the strut at the lower edge thereof, while a concave could be formed into the base around the groove at the lower part of the groove, in which the length from a tip of one projection to the other is slightly larger than the width of the groove to enable the projections to engage with the concave.

Preferably, a protrusion may be formed upwards from a front edge of the base.

Preferably, a lump could be formed on a surface of the strut facing to the cover, while a corresponding hole could be formed in the cover to contain the lump when the stand is in the folded state, in which the size of the lump is slightly larger than that of the hole.

### BRIEF DESCRIPTION OF THE DRAWINGS

The present invention will be described in details with reference to the accompanying drawings, in which:

FIG. 1 is a perspective view of an embodiment of the foldable stand for portable handheld electronic device according to the present invention;

FIG. 2 is a side view of the foldable stand shown in FIG. 1;

FIG. 3 is a perspective view of the foldable stand for portable handheld electronic device in a folded state;

FIG. 4 is a bottom view of the foldable stand shown in FIG. 3; and

FIG. 5 illustrates the use of the foldable stand for portable handheld electronic device according to the present invention.

### DETAILED DESCRIPTION OF THE INVENTION

The aspects, features and advantages of the present invention will be better understood by those skilled in the art from the detailed description of the embodiments of the invention in conjunction with the accompanying drawings. Exemplary embodiments of the present application and the description thereof are for illustration purpose only, and should not be construed as limitation to the protective scope of the present invention.

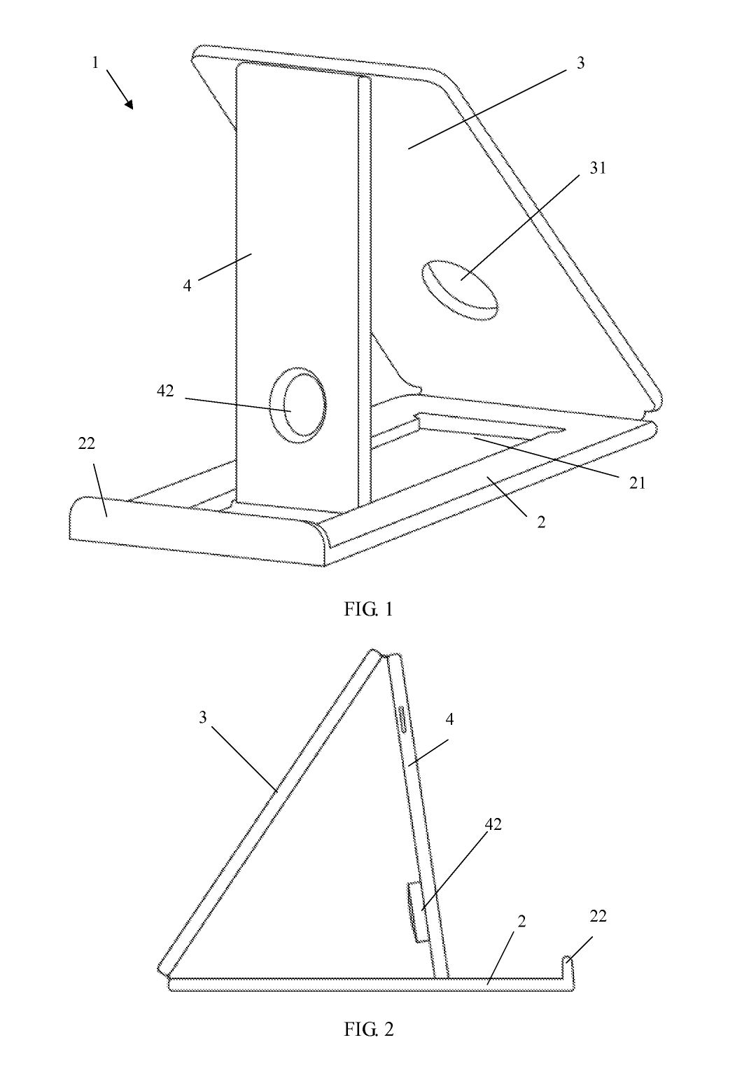

FIG. 1 illustrates an embodiment of the foldable stand for portable handheld electronic device according to the present invention. As shown in FIG. 1, the stand 1 comprises a base 2 and a cover 3 pivotably connected to the base 2. The cover 3 could be connected to the base 2 by virtue of a pivot, a hinge or other means known in this art. Or, the cover 3 could be formed integrally with the base 2 and a joint part therebetween is relative thinner than the other parts, to enable the cover 3 to be pivotable with respect to the base 2.

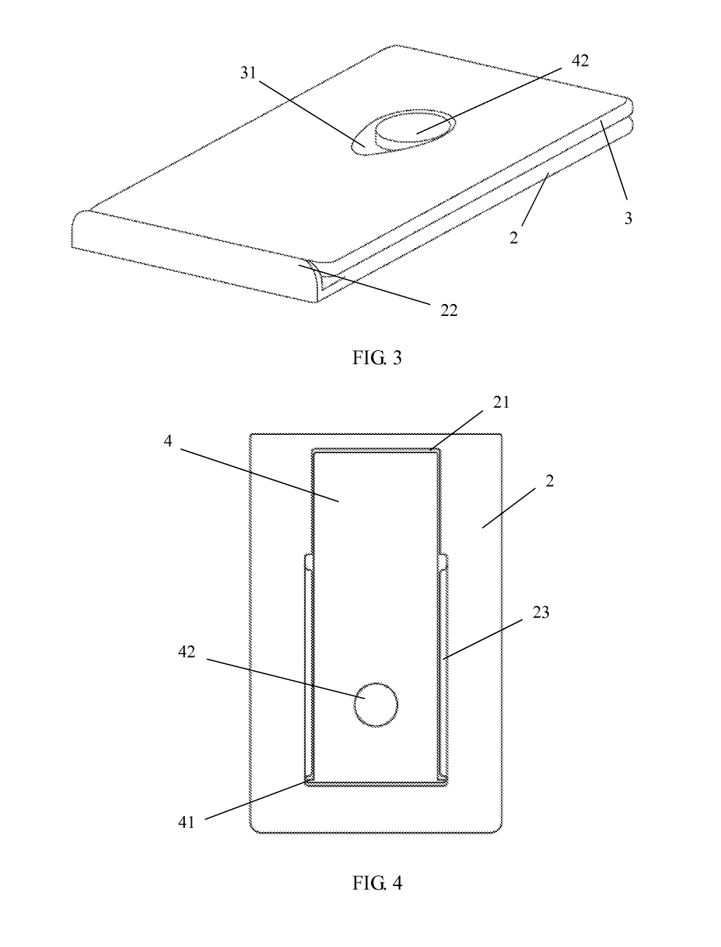

A groove 21 is formed into an upper surface of the base 2 between the base 2 and the cover 3, and a strut 4 is pivotably connected to the cover 3 at an upper edge thereof, while is slidably mounted in the groove 21 at a lower edge thereof. The groove 21 is formed in such a manner that it could contain the whole strut 4 when the cover 3 is closed with respect to the base 2, as shown in FIG. 3. The groove 21 could be formed into part of the thickness of the base 2, or be formed through the whole thickness thereof.

The base 2, the cover 3, and the strut 4 could be made of, such as plastics, rubbers, metals, ceramics, or other suitable materials.

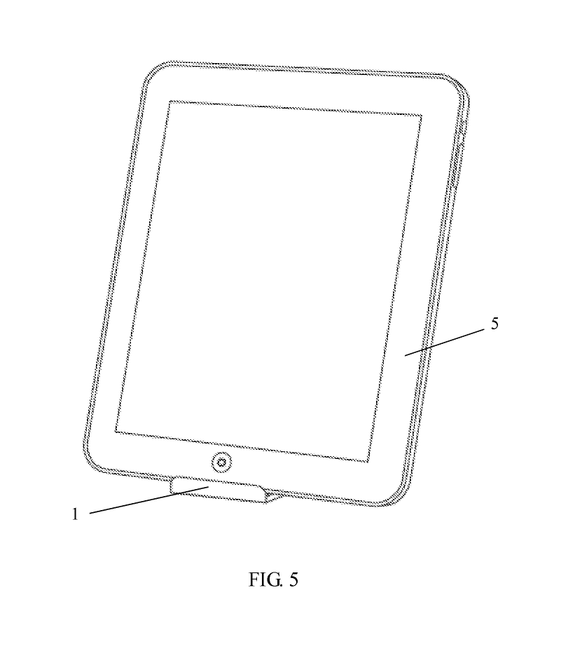

To form the configuration of FIG. 1 from a folded state of FIG. 3, the cover 3 would first be opened by pivoting it around the base 2. With the opening of the cover 3, the strut 4 would be pivoted around the cover 3 on one hand, and the lower edge of the strut 4 would slide along the groove 21 on the other hand. Finally, the base 2, the cover 3 and strut 4 would form a stable triangle, just like the configuration of FIG. 1. As a result, as shown in FIG. 5, an electronic device 5 could be supported on the stand 1, in which one side of the device presses against the base 2 and the back of the device rests on the strut 4 or presses against the cover 3.

To prevent the electronic device 5 from sliding off from the base 2, a protrusion 22 could be formed upwards from the front edge of the base 2.

As shown in FIG. 4, a projection 41 may extend outwards from each side of the strut 4 at the lower edge thereof, while a concave 23 may be formed into the base 2 around the groove 21 at the lower part of the groove 21. The total length from the tip of one projection to the other is slightly larger than the width of the groove 21. Thus, the projection 41 could engage with the concave 23 to prevent the lower edge of the strut 4 from being pulled out from the groove 21.

As clearly shown in FIG. 2, a lump 42 could be formed on a surface of the strut 4 facing to the cover 3, while a corresponding hole 31 could be formed in the cover 3 to contain the lump 42 when the stand is in the folded state. The size of the lump 42 is slight larger than that of the hole 31, thus after the lump 42 is pressed into the hole 31, the stand would not be unfolded accidentally.

Although some embodiments of the present invention have been shown and described with reference to the accompanying drawings, those skilled in the art should understand that various changes and modifications can be made to the embodiments without departing the principles and spirits of the present invention and they still fall into the scope of claims and the equivalent thereof.

What is claimed is:

1. A foldable stand for portable handheld electronic device comprising:
a base into an upper surface of which a groove is formed;
a cover pivotably connected to the base for covering the upper surface of the base;
a strut pivotably connected to the cover at an upper edge thereof and slidably mounted in the groove at a lower edge thereof;
wherein the groove is formed in such a manner that it could contain the strut when the cover is closed with respect to the base.

2. The foldable stand according to clam 1, wherein a projection is formed outwards from each side of the strut at the lower edge thereof, while a concave is formed into the base around the groove at the lower part of the groove, in which the length from a tip of one projection to the other is slightly larger than the width of the groove to enable the projections to engage with the concave.

3. The foldable stand according to claim 1, wherein a protrusion is formed upwards from a front edge of the base.

4. The foldable stand according to claim 3, wherein a lump is formed on a surface of the strut facing to the cover, while a corresponding hole is formed in the cover to contain the lump when the stand is in the folded state, in which the size of the lump is slightly larger than that of the hole.

5. The foldable stand according to claim 2, wherein a protrusion is formed upwards from a front edge of the base.

6. The foldable stand according to claim 5, wherein a lump is formed on a surface of the strut facing to the cover, while a corresponding hole is formed in the cover to contain the lump when the stand is in the folded state, in which the size of the lump is slightly larger than that of the hole.

7. The foldable stand according to claim 1, wherein a lump is formed on a surface of the strut facing to the cover, while a corresponding hole is formed in the cover to contain the lump when the stand is in the folded state, in which the size of the lump is slight larger than that of the hole.

8. The foldable stand according to claim 2, wherein a lump is formed on a surface of the strut facing to the cover, while a corresponding hole is formed in the cover to contain the lump when the stand is in the folded state, in which the size of the lump is slight larger than that of the hole.
